(19) United States
(12) Patent Application Publication
(10) Pub. No.: US 2014/0276271 A1
(43) Pub. Date: Sep. 18, 2014

(54) WEARABLE PERCUSSION/VIBRATION DEVICE

(71) Applicant: Stryker Corporation, Kalamazoo, MI (US)

(72) Inventors: Martin W. Stryker, Kalamazoo, MI (US); Scott Davis, Oshtemo, MI (US); Thomas William Granzow, Plainwell, MI (US)

(73) Assignee: Stryker Corporation, Kalamazoo, MI (US)

(21) Appl. No.: 14/204,010

(22) Filed: Mar. 11, 2014

Related U.S. Application Data
(60) Provisional application No. 61/787,576, filed on Mar. 15, 2013.
(60) Provisional application No. 61/780,037, filed on Mar. 13, 2013.

(51) Int. Cl. A61H 23/04; A61H 23/00

(52) U.S. Cl. CPC A61H 23/04; A61H 23/00
USPC 601/46; 601/107

(57) ABSTRACT

A wearable device for vibration and/or percussion treatment, such as a covering configured to be worn by a person, such as patient, around the chest of the person, a plurality of actuators provided at the covering, and a control system in communication with the actuators and configured to provide independent and sequential operation of the actuators to generate progressive constriction and relaxation for providing movement of material in a person's lungs in the direction of the sequential operation of the actuators.

### CROSS-REFERENCE TO RELATED APPLICATION

This application claims the benefit of U.S. Provisional Patent Application No. 61/787,576, filed Mar. 15, 2013, and U.S. Provisional Patent Application No. 61/780,037, filed Mar. 13, 2013, which are both incorporated herein by reference in their entirety and commonly owned by Stryker Corporation of Kalamazoo, Mich.

### TECHNICAL FIELD AND BACKGROUND OF THE INVENTION

The present invention relates to percussion/vibration treatment for a patient, and more specifically to a device that can be worn by the patient that can provide percussion/vibration treatment.

Various respiratory afflictions require therapy to “breakup” and reduce the buildup of phlegm and congestion in the lungs. Various methods are in practice today to accomplish this. This includes percussion therapy, both manual, automated and semi-automated (typically mechanical hand-held devices), massage, and various positional exercises to break up and move the congestion (guck) out of the patient's lungs. In particular cystic fibrosis in children requires regular therapies of this type.

### SUMMARY OF THE INVENTION

The present invention provides a device that can facilitate the movement of the mucus or phlegm toward expulsion from the mouth, without the need for manipulation or the use of a vacuum device, though manipulation or vacuum, for example regulated by a control unit, may be used to assist if desired.

In one form of the invention, a covering, such as a garment or wrap, which is adapted to be worn by a patient, incorporates a plurality of actuators that can be independently and sequentially used to generate progressive constriction and relaxation that provides movement of the loose matter or material in the direction desired.

In one aspect, the actuators may comprise a bladder with pneumatically isolated chambers. These chambers form actuation nodes or regions that are spaced from each other so that sequential constriction or compression may be applied to the patient's body.

The bladder may be wrapped radially about the patient's chest area to form an open loop or ring around the patient's chest and secured via external devices, such as a fabric vest or wrap, and may be further secured about the patient, by belt or straps and or fasteners, such as hook and loop fasteners or the like. Alternately, the bladder may be incorporated into a slip on garment such as a shirt-like garment.

In another embodiment, each chamber may be connected pneumatically to an air source via tubing which can transmit variations in air pressure to the chambers. The chambers are first inflated to a desired pressure of generally equal value, which represents a base pressure. After inflation to the base pressure, each chamber can be individually pressurized to a higher pressure for a short duration of time forming a pulse pressure, providing a “shock wave” to the lungs affecting a dislodging effect to the lung cavity. By progressively sequencing each of the chambers in the direction of the head, movement of the loosened matter can be moved in that direction. The progressive inflation/deflation of the chambers provides a “wave” upwards toward the upper lungs and out the mouth.

For example, the base pressure may vary in a range of about 10 and 50 PSI. The higher pulse pressure may vary in a range of about 25 to 90 PSI. The higher pulse pressure may have a frequency in a range of about 20 and 600 Hz, and more typically in a range of about 100 to 500 Hz, and most typically in a range of about 250 to 350 Hz.

The chambers may be totally isolated and individually controlled, or may have small air passages between them to allow for equalization during initial inflation, but small enough to not significantly diminish the “pulse” due to leakage between chambers during percussion.

The pressure pulses may be provided by a variety of pneumatic devices, which may include pistons sequentially timed, electric solenoids, rotary distribution, or any method that can provide a short burst of pressure to the chambers or bladders. Typically the method involves applying a base line pressure and then a short increase in pressure above the base line pressure then subsequent decrease in pressure, for example back to the base line pressure, which may be provided by the movement of a diaphragm that is actuated then relieved, for example, by a piston that compresses then decompresses, or any other pneumatic oscillation device.

In addition, a control system may be provided that allows for independent control of the base pressure, pulse pressure cycle frequency, and pulse pressure magnitude, which can make the device tunable. The control system may also control the temperature in the case of a pneumatic based system.

In addition to accomplishing this progressive constriction and relaxation pneumatically, the progression could be generated by mechanical devices, such as a solenoid or a nichrome “memory wire” technology. For example, the mechanical device may include a band or bands, which are then tightened, for example, by a solenoid device.

In another embodiment, each chamber may be formed by a separate bladder so that the device may include multiple discrete bladders, each with one or more chambers.

In any of the above, the actuation nodes or regions may be physically arranged generally in parallel but may be operated in series. Further, the number of nodes or regions may vary according to the patient and what is being treated. For example, the number of nodes or regions may vary from 3 to 17, from 5 to 10, including 5—with one for each of the five lobes of the lungs.

According to yet another aspect, actuators may comprise a pad with segments or individual pads that form the plurality of actuation nodes or areas. The pads may comprise electrically actuated vibration pads. The pads may also apply a base pressure by way of how they are secured to the patient. For example, the pad or pads may be secured by a vest or straps, which compress the pad against the patient. The pulsed high pressure is then generated when the vibration pads are electrically actuated.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF DRAWINGS

FIG. 1 is a perspective view of a device shown worn by a patient, which is suitable for applying vibration/percussion treatment to a patient's chest;

FIG. 1A is a similar view to FIG. 1 showing the device alone;

FIG. 1B is a front elevation view of the device of FIG. 1;

FIG. 1C is a back elevation view of the device of FIG. 1;

FIG. 2 is a back elevation view of a device of FIG. 1 illustrating each of the chambers or pads being coupled to a respective tube or power cord for controlling the bladders or pads;

FIG. 2A is a similar view to FIG. 2 showing the device alone;

FIG. 3 is a similar view to FIG. 2 with an alternate embodiment of bladders or pads of the present invention;

FIG. 4 is a similar view to FIG. 2 illustrating additional pads or bladders at the upper portion of the device;

FIG. 5 is similar view to FIG. 1 illustrating another embodiment of the device;

FIG. 5A is similar view to FIG. 5 illustrating yet another embodiment of the device;

FIG. 6 is a flow chart describing the sequence of steps for using a device of the present invention;

FIG. 7 is a similar flow chart illustrating the sequence of steps for using a device with bladders;

FIG. 8 is a perspective view of yet another embodiment of a device of the present invention;

FIG. 9 is a perspective view of yet another embodiment of a device of the present invention;

FIG. 9A is a partial cross-section of the device of FIG. 9; and

FIG. 10 is a graphical representation of an optional pressure cycle.

### DETAILED DESCRIPTION OF PREFERRED EMBODIMENTS

Referring to FIG. 1, the numeral 10 generally designates a device of the present invention, which is configured to apply sequential compression or constriction of a patient's chest to facilitate breaking up and reducing the buildup of phlegm and congestion in the lungs. As will be more fully described below, the device may incorporate a plurality of actuators, which are controlled to create the sequential compression or constriction of a patient's chest. Furthermore, as will be more fully described below, the device may incorporate a control system to control the actuation of the respective actuators and further provide for adjustment to the parameters of the sequential compression or constriction steps to render the device tunable.

Referring to FIG. 1, device 10 includes a plurality of actuators 12, which in the illustrated embodiment may be formed by a plurality of open loops or rings of pads or pad segments or chambers 12A, 12B, 12C, 12D, and 12E, which are secured to or form part of a vest 14, which can be worn by a patient. Further, each of the respective loops 12A-12E may be secured at their respective ends by fasteners 16, such as belts, straps, or hook and loop fasteners, which allow the loops or rings to be selectively tightened about the patient's chest, for example, to apply a base pressure to the chest of the patient.

The chambers may be formed by two sheets of flexible, impermeable material welded together to form a bladder and with the bladder segmented into smaller regions or segments that form the chambers. For example, the chambers may be formed by welds, which then define the boundaries of the chambers. The chambers may extend full length of the loops or the rings or may terminate in the middle or at some other point around the loop, with the remainder of the loop forming another chamber or chambers. Air inlets are then welded or otherwise formed in the sheets to allow coupling to air supply tubing noted below. Alternately, each loop or ring may be formed from a separate bladder, which may then be joined together.

As noted, each of the loops or rings may be formed by chambers provided by bladders or bladder segments, which may be inflated and deflated to apply the sequential compression or constriction on the patient's chest. For example, the chambers may be inflated to a base pressure Pb and thereafter each one is sequentially inflated to a pulse pressure Pp that is applied for time T to thereby affect a vibration/percussion treatment. The form of the pulse may vary, as more fully described below in reference to FIG. 10.

Referring again to FIG. 1, device 10 includes a control system 18 to control the actuators. Control system 18 includes circuitry, a power supply, a pneumatic air supply 20, selectively operable valving (not shown), and a plurality of tubing 22a-22e (such as shown on FIG. 2) which selectively deliver air to the respective chambers from air supply 20. Suitable circuitry may include one or more microcontrollers, microprocessors, and/or other programmable electronics that are programmed to carry out the functions described herein, which may be mounted on one or more circuit boards. Although not shown, it should be understood that the pneumatic supply may include a manifold that includes the selectively operable valving, such as solenoid valves, which are operated by control system 18 (e.g., a microprocessor) to selectively deliver air from the pneumatic supply to the tubing and then to the respective chambers.

For example, control system 18 may initially inflate each chamber to the base pressure, and then direct increased air flow (pulse pressure) to chamber 12E and then followed by suction to reduce the pressure back to the base pressure, followed by increased air flow (pulse pressure) to chamber 12D and then followed by suction to reduce the pressure back to the base pressure, followed by increased air flow (and hence pressure) to chamber 12C and then followed by suction to reduce the pressure back to the base pressure, followed by increased air flow (pulse pressure) to chamber 12B and then followed by suction to reduce the pressure back to the base pressure, and then by followed by increased air flow (pulse pressure) to chamber 12A and then followed by suction to reduce the pressure back to the base pressure. These steps can be repeated until the lungs are found to be sufficiently cleared. Alternatively, the control system may apply a pulse to chambers that are not adjacent to one another, for example, to chamber 12E and then to chamber 12C, then to chamber 12A, depending on treatment protocol.

As noted above, chambers 12A-12E may comprise pneumatically isolated chambers. Alternatively, the chambers may have small air passages between them to allow for equalization during initial inflation but which are small enough not to significantly diminish the pulse due to leakage between the chambers during percussion. In either case, the increased air flow is followed by a removal of some of the air from the respective chamber via the tubing to create the pulsed pressure or each bladder may include a relief valve that allows the air to escape once the pressure reaches a predetermined maximum pressure.

Chambers 12A-12E therefore form actuation nodes or regions which are spaced from each other and further are arranged in parallel. By pulsing the pressure in the chambers serially, device 10 is able to generate sequential constriction or compression that can be applied to the patient's chest that moves from the bottom of the patient's chest up to or near the top of the patient's chest. Although described as being arranged in parallel and operated in series, the chambers may be arranged in groups to apply sequential compression to a discrete region of the chest so that some chambers associated with other regions may not be in parallel and further not actuated, such as shown in FIG. 5A, described below.

While five loops are illustrated, it should be understood that the number of loops, nodes or regions may be varied according to the patient and for what is being treated. For example, the number of loops, nodes or regions may vary from 3 to 17, from 5 to 10, including, as noted, 5 loops, nodes or regions with one loop, node or region for each of the five lobes of the lung.

As noted above, actuators 12 may be formed by vibration pads or vibration coils, as described below. The vibration pads are actuated by electrical current, also controlled by the control board of control system 18 and further operated in a similarly manner to that described above in reference to chambers 12A-12E.

In addition, although illustrated and described as being formed from a bladder which is divided into multiple chambers, it should be understood that the actuators may be formed by multiple discrete bladders, each with one or more chambers, instead.

In reference to FIG. 3, device 10 may also include additional actuators 24 at the upper back side of, for example, vest 14, which also may be controlled by control system 18 and, further may comprise pneumatic actuators, such as chambers or pads 24f and 24g which are supplied with air or current by way of tubing or wiring 22f and 22g controlled by control system 18. In this manner, actuators 24 may provide localized vibration/percussion treatment to an upper back portion patient's chest. For example, actuator 24f may provide vibration/percussion treatment to the left back side of the patient's chest, while actuator 24g may apply vibration/percussion treatment to right back side of the patient's chest.

It should be understood that the additional actuators 24 may be provided, such as shown in FIG. 4, to the front of the vest so that such as actuators 24h and 24i, which respectively apply vibration/percussion treatment to the left front side or right front side of the patient's chest. As would be understood from the foregoing description, the device may have actuators that are located to customize the treatment and also modified to account for the difference between adults and children. Further, actuators 24 may comprise chambers or pads similar to actuators 12.

Referring to FIG. 5, the numeral 110 generally designates another embodiment of the device of the present invention. Device 110 similarly includes the plurality of actuators 112, which are controlled via a similar control system to that described in reference to first embodiment. As best seen in FIG. 5, each actuator may be configured to cover different regions of the chest than covered by the actuators in the first embodiment and, therefore, may differ in their shape and/or size, e.g. have regions of increased thickness or regions which are offset from other regions. Further, similar to device 10, actuators 112 may be formed by pneumatic chambers or pad or pad segments or vibration coils.

Alternatively, as shown in FIG. 5A, a device 210 of the present invention may incorporate a plurality of actuators arranged in groups, for example, to align with and for treatment of discrete regions of the lungs. For example, the groups may be provided and arranged for treatment of the left lung or the right lung independently of the other. Or as shown in the illustrated embodiment, a group of actuators may be provided for each lobe of the lung.

As best seen in FIG. 5A, device 210 include a first group of actuators 212a for the right upper lobe, a second group of actuators 212b for the right middle lobe, a third group of actuators 212c for the right lower lobe, a fourth group of actuators 212d for the right lower lobe, and a fifth group of actuators 212e for the right upper lobe. Each group of actuators may be formed form a plurality of chambers, pads or pad segments and be similarly controlled by a control system such as described in reference to the previous embodiments. For example, the control system may actuate each actuator in the respective group sequentially, either by themselves of in conjunction with one or more other groups of actuators so that a single lobe or several lobes can be treated.

In this manner, the device may be configured to apply vibration/percussion treatment to discrete regions of the chest, for example to one or more lobes of the lungs, while leaving another lobe or lobes of the lungs untreated.

The control systems of each of the devices may have software programs stored, for example, in memory on the control board, which may be updated via RF communication or via a USB port or both, which components (e.g. receiver/transceiver and USB port) may be provided in the control system, for example, on the control board or peripheral boards. Further, the programs may be selected by a user input device, such as a display and/or keyboard and/or via a remote controller, which are in communication with the control board.

Additionally, air supply may be provided by an onboard system, such as described in issue U.S. patent no. 2008/0250564, which is incorporated by reference herein its entirety and is commonly owned by Stryker Corporation of Kalamazoo Mich.

While illustrated as being mounted to or being formed as part of the vest 14, it should be understood that the device of the present invention may be configured simply as a wrap or other coverings that can be worn by the patient, including a shirt-like garment. Furthermore, the actuators may be mounted to the patient's chest directly by way of straps which may extend around the patient's chest and are secured at their respective ends to thereby to secure the actuators in place. Thus, the straps themselves may supply the base pressure to the patient's chest, while the actuators are operated then to apply the increased pulse pressure.

Referring to FIG. 6, the control system may be configured to initiate a pulse pressure at a node or region 1 and then generate a pulse pressure at a node or region 1+N, where N as an integer. Optionally, after all the actuator nodes or regions are sequentially actuated to apply the pulse pressure, the control system may then stop the treatment or may repeat the process until the lungs are sufficiently clear. Or as noted above, alternating actuation nodes or regions may be actuated.

As noted above, and with reference to FIG. 7 when employing chambers as actuators, the control system optionally inflates the chambers first to a desired pressure, generally of equal value, which represents a base pressure. After inflation to the base pressure, the control system then individually and sequentially pressurizes the chambers (e.g. starting with 12E, moving to 12D, to 12 C, to 12B, and then to 12A as noted above) to a higher pressure for a short duration for a period T to form the pulse pressure, which provides in essence a shock wave to the lungs affecting a dislodging effect to the lung cavity.

By progressively sequencing the generation of pulse pressures in each of the bladders or pads in the direction of the head, movement of the loose matter or material can be forced to move in that direction. The progressive inflation/deflation of the chambers or bladders or pad provides a “wave” upwards to the upper lungs and then out of the mouth.

For example, the base pressure may vary for example in a range of about 10 to 50 PSI. The higher pulse pressure may vary in range of about 20 to 90 PSI. A higher pulse pressure may have a frequency in a range of about 20 to 600 Hz, and more typically, in a range of about 100 to 500 Hz, and most typically in a range of about 250 to 350 Hz.

The pulse may be provided by a variety of pneumatic devices, which include sequentially timed pistons, electric solenoids, rotary distribution, or any other method that can provide a short burst of pressure to the chambers. For example, the method may include applying a short increase in pressure then a subsequent decrease in pressure, which may be provided by the movement of a diaphragm, for example, that is actuated then relieved, for example, by a piston that compresses and decompresses, or any other pneumatic oscillation device.

In addition, the control system may be configured to allow independent control of the pulse pressure cycle frequency and the pulse pressure magnitude, which can make the device tunable.

In addition to accomplishing this progressive constriction and relaxation pneumatically, as noted, the progression can be generated by mechanical devices such as the described pads or by a solenoid or solenoids or a micron memory wire technology. For example, the covering may incorporate a plurality of memory wires, for example, located around the patient's chest which when actuated by electrical current will contract to apply constriction or compression to the patient's chest.

Beyond pressure, the control system may also, in the case of a pneumatic system, vary the temperature. For example, pump 20 may incorporate a heating and/or cooling device, including for example a Peltier device, to warm or cool the fluid flowing through the device.

Referring to FIG. 8, numeral 410 generally designates another embodiment of an actuator of the present invention. Actuator 410 includes one or more bands 412 which are connected at their respective opposed ends by a device 414, which is configured to constrict or expand to apply tension on the ends of bands 412. When the bands are placed around a patient, bands 412 thereby increase the pressure on the patient's chest. Further, when device 410 is worn by a patient, bands 412 will be placed around the patient's chest and secured in a manner to apply an initial base tension on the belt to apply a base pressure to the patient. In this manner, when devices 414 constrict, additional tension will be applied at the ends of bands 412 to increase the pressure from the base pressure to an increased pressure which is thereafter released to generate a pulse pressure on the patient's chest. For example, device 414 may comprise a solenoid that is powered by the control unit via electrical line 416. Devices 414 may also comprise powered devices with receivers or transceivers so that they can be remotely actuated, for example, by a control system.

As noted device 410 may be formed by a plurality of bands 412 in a similar manner to the previous embodiments. For example, the number of bands may range from 3 to 17, 5 to 10, or more typically 5. In this manner, the bands may be sequentially actuated to create the desired progressive constriction and relaxation.

Referring to FIGS. 9 and 9A, the numeral 510 generally designates yet another embodiment of the present invention. Device 510 is similarly formed from a band 512, which is joined at its opposed ends by a coupler 514. Device 510 may also be formed by multiple bands, such as shown on FIG. 9A, to generate the desired progressive constriction or relaxation. In the illustrated embodiment, band 512 incorporates a plurality of coils, such as electromagnetic coils, which when stimulated generate vibration. For example, coils 516 may be powered by a control unit via electrical lines 516. Further, the coils may be self-powered and include a receiver or a transceiver to receive actuation signals from a control unit. Again the number of bands may vary with each band being actuated or alternate bands being actuated to thereby supply progressive constriction or relaxation.

In a similar manner, when worn by a patient, coupler 514 is tightened to a base tension so that the bands 512 apply a base pressure to the patient, with the pulsed-pressure applied by coils 516. Again, the coils 516 may be actuated in series starting with, for example, a lower most band, followed by the next band and so on.

Referring to FIG. 10, as previously noted, the progressive constriction or relaxation may be applied by a pulse pressure 312 which may take several forms. Referring to FIG. 10, pulse pressure 312 may be applied by simple sinusoidal wave about the base or base line pressure 310. Generally, pulse pressure 312 generates an increase in pressure of “X” above the base pressure and then is reduced to a negative pressure “−X”, both centered about the base line pressure 312. While shown as a sinusoidal wave, with equal amplitude and period, it should be understood that the pulse pressure may have a digital, stepped profile centered about the base pressure. In addition, the amplitude or frequency of the pulse may vary for a given cycle. For example, the pulses may initially start off with a first amplitude and then increase over the cycle (for example linearly) with each pulse to a maximum amplitude and then repeat the cycle. Similarly, the frequency may change over a cycle, for example, the pulse may start with a large period (or low frequency) changing over the cycle, (e.g., linearly) to a short period (or high frequency) at the end of the cycle.

While several forms of the inventions have been shown and described, the above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert but which can be used independently and/or combined with other features. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

We claim:

1. A wearable device for vibration and/or percussion treatment:
a covering configured to be worn by a person around the chest of the person;
a plurality of actuators provided at said covering; and
a control system in communication with said actuators and configured to provide independent and sequential operation of said actuators to generate progressive constriction and relaxation for providing movement of loose matter in a person's lungs in the direction of the sequential operation of the actuators.

2. The wearable device according to claim 1, wherein the actuators comprise a pneumatic bladder, said bladder having a plurality of chambers, said chambers forming spaced actuation regions or nodes, and said control system directing air flow to said chambers to pressurize the chambers generally to a base pressure and directing air flow to the chambers to generate increased pressure in the chambers sequentially which when worn by the person applies sequential compression or constriction to the person's chest.

3. The wearable device according to claim 2, wherein the chambers are positioned to align with preselected regions, such as lobes or zones, of the person's lungs.

4. The wearable device according to claim 2, wherein the chambers are grouped into five regions, with each region for aligning with and corresponding to a lobe of the person's lungs.

5. The wearable device according to claim 2, wherein the chambers are configured to form open loops around the person's chest.

6. The wearable device according to claim 5, wherein the loops are arranged generally in parallel, but are controlled by said control system in series.

7. The wearable device according to claim 2, wherein said control system includes a pneumatic supply of air and tubing to selectively direct the air from the pneumatic supply to the chambers.

8. The wearable device according to claim 1, wherein the actuators comprise a plurality of pneumatic bladders, each bladder forming an actuation region or node, and said control system directing air flow to said bladders to a base pressure and selectively applying increased pulse pressure to one of the bladders independent of the other bladders.

9. The wearable device according to claim 8, wherein the control system is configured to provide independent control of the base pressure, cycle frequency of the pulse pressure, and pulse pressure magnitude.

10. The wearable device according to claim 1, wherein the actuators comprise a plurality of vibration pads, each pad forming an actuation region or node, and said control system controlling selectively causing said pads to vibrate sequentially and independent of the other pads.

11. The wearable device according to claim 10, wherein the pads are configured to apply a base level pressure to the person's chest.

12. The wearable device according to claim 1, wherein the actuators are mounted to or in a vest.

13. A wearable device for vibration and/or percussion treatment:
a covering configured to be worn by a person around the chest of the person;
a plurality of bladders provided at said covering;
a supply of air; and
a control system in communication with said supply of air and said bladders, said control system configured to control the flow of air from said air supply to said bladders to inflate or deflate said bladders in a sequence to provide progressive constriction and relaxation to the chest of the person wearing the device to induce movement of loose matter in a person's lungs in the direction of the sequential operation of the bladders.

14. The wearable device according to claim 13, wherein said bladders are arranged to form a plurality of adjacent open loops for extending around the chest of the person wearing the device, said bladders forming spaced actuation regions or nodes.

15. The wearable device according to claim 14, wherein said loops are generally parallel.

16. The wearable device according to claim 13, wherein said control system is configured to direct air flow to said bladders to pressurize the bladders to a base pressure and is configured to direct air flow to a first selected bladder to generate increased pressure over said base pressure in said first selected bladder, and said control system being configured to deflate said first selected bladder generally back to said base pressure and to direct air flow to a second selected bladder to generate increased pressure over said base pressure in said second selected bladder.

17. The wearable device according to claim 16, wherein said first selected bladder is adjacent said second selected bladder.

18. The wearable device according to claim 13, wherein said bladders form pneumatically isolated chambers.

19. A method of applying sequential compression to a person's chest, said method comprising the steps of:
locating a plurality of actuators about a person's chest;
controlling the actuators to apply pulses of pressure to the person's chest; and
wherein said controlling includes causing the actuators to apply pulses in a sequence to generate sequential compression on the person's chest.

20. The method according to claim 19, wherein said controlling further includes causing the actuators to apply a base pressure to the person's chest and then to apply a pulse of increased pressure over of the base pressure in a sequence.
